(19) United States
(12) Patent Application Publication
(10) Pub. No.: US 2019/0141080 A1
(43) Pub. Date: May 9, 2019

(54) Apparatus for Comprehensive IoT Testing

(71) Applicant: Gazos Creek, Inc, Buellton, CA (US)

(72) Inventors: Steven Albert Kiss, Buellton, CA (US); Alan Micheal Penzotti, Campbell, CA (US); Stacey Marie Glasgow, Buellton, CA (US)

(73) Assignee: Gazos Creek, Inc, Buellton, CA (US)

(21) Appl. No.: 15/807,228

(22) Filed: Nov. 8, 2017

(51) Int. Cl. H04L 29/06; H04L 29/08

(52) U.S. Cl. CPC H04L 63/20; H04L 63/08; H04L 67/12

(57) ABSTRACT

A system for providing baseline compliance with data security standards for industrial and commercial devices that are connected to communications networks with TCP/IP protocols. This system will allow for verification of wired and wireless devices and connected components. This testing criteria will provide testing to an expanded primitive class of devices including Sensor, Aggregator, Communications Channel, eUtility, Decision Trigger and Actuator

The system will provide testing, retesting and display of compliance, commercial and government recommendations and standards. This testing will comprise device, local network, security appliance and cloud based resources into one security dashboard.

### CROSS REFERENCE TO RELATED APPLICATION

Provisional patent receipt attached.

### BACKGROUND ON THE INVENTION

IoT devices have been a growing industry with diverse instruments, devices, products, hardware and software coming to the market. These products are incredibly diverse and may include, but are not limited to, water treatment valves, air handlers, thermostats, energy use meters, public transportation guidance systems, integrated security systems and crowd analytic engines. These individual components, accompanying transport, storage and analytics often rely upon disparate building blocks to operate.

Recently, the development of cloud based (Internet hosted software) services have allowed internet of things manufacturers to directly connect sensors and aggregators to the cloud. This only exasperates the problem as the sensor/aggregator manufacturer as they are not in control of all aspects, particularly transport and storage. By creating a cohesive view across all IoT devices level testing, suers, developers and data analytics expert can have a greater confidence in the safety and security of deployments. The current method of testing utilizes various stand alone methods to testing. Even the most secure testing regiments are done by testing each element individually and not looking at the overall security.

Certain methods of testing have been developed for other industry specific verticals. However, these methods do not address the underlying lightweight nature of the sensor, the need to vary tests based on sensor capabilities or the diverse use of data in the field of analytics across multiple processors. The current method is to test each component in isolation.

Another drawback is that users, such as facilities and IT experts, do not have a uniform method to evaluate the security merits of one product over another. Therefore, a need exist in the field for novel uniform apparatuses cable of uniformly testing and reporting security of Internet of Things ecosystems. A further need exist for a method to rank the various products, services, capabilities offerings and the like. The present invention comprises a novel testing device generally consisting of groups of software routines from virus vendors and communities that allow for uniform testing of IoT devices associated devices, networks, storage, transport and manipulation. The applications are through an interface referred to as the master configuration interface with rank gins identified in the summary of test interface screen. The system will utilize traditional hardware in the form processors, NICs, memory and storage to support all aspect of the apparatus. The system can perform the task in a distributed manner so long as the subsequent data is collected for system level review. Moreover, the apparatus' software can interface directly with the hardware or can be abstracted through the use of victual machines to increase performance, reduce network load or otherwise generally scale.

### BRIEF SUMMARY OF THE INVENTION

The present invention relates to novel testing and evaluating of security for Internet of Things (IoT) devices. More particularly, the invention relates to an electronic device that is capable of testing the security of Internet of Things devices and systems.

### BRIEF DESCRIPTION OF DRAWINGS

Some embodiments of the present invention are illustrated as an example and are not limited by the figures of the accompanying drawings, in which like references may indicate similar elements and in which:

FIG. 1 depicts a list of core features of software dashboard.

FIG. 2 shows the apparatus as a combined layer 3 device incorporating firewall, router, switch (with interface mirroring to packet capture device), packet generation, and penetration testing on all lab and Internet facing interfaces to exhaustively simulate and capture any test deployment scenario.

### DETAILED DESCRIPTION OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion.

Nevertheless, the specification and claims should be read with the understanding that such combinations are entirely within the scope of the invention and the claims and also include new testing devices, apparatuses, and methods for evaluating IoT devices. In the following description, for purposes of explanation, numerous specific details are set forth in order to provide a thorough understanding of the present invention. It will be evident, however, that the present invention may be practiced without these specific details.

The present disclosure is to be considered as an exemplification of the invention, and is not intended to limit the invention to the specific embodiments illustrated by the figures or description below.

The present invention will now be described by referencing the appended figures representing preferred embodiments.

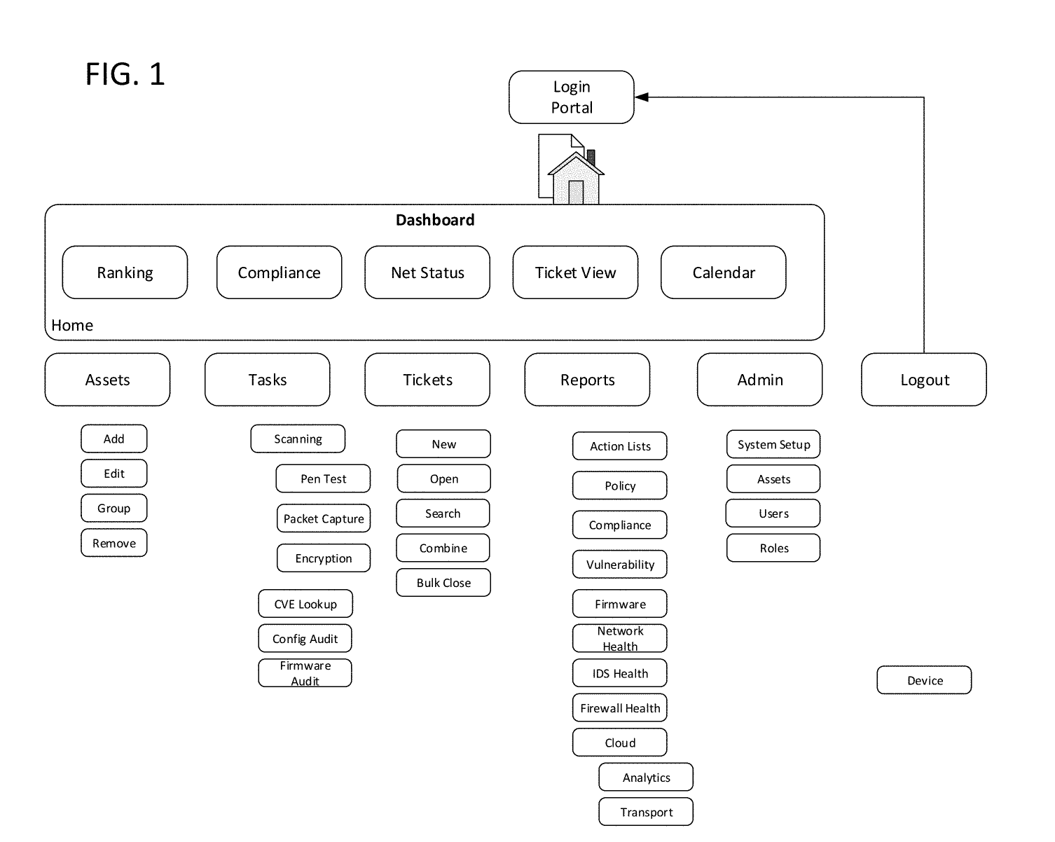

FIG. 1 depicts a list of core features of software dashboard.

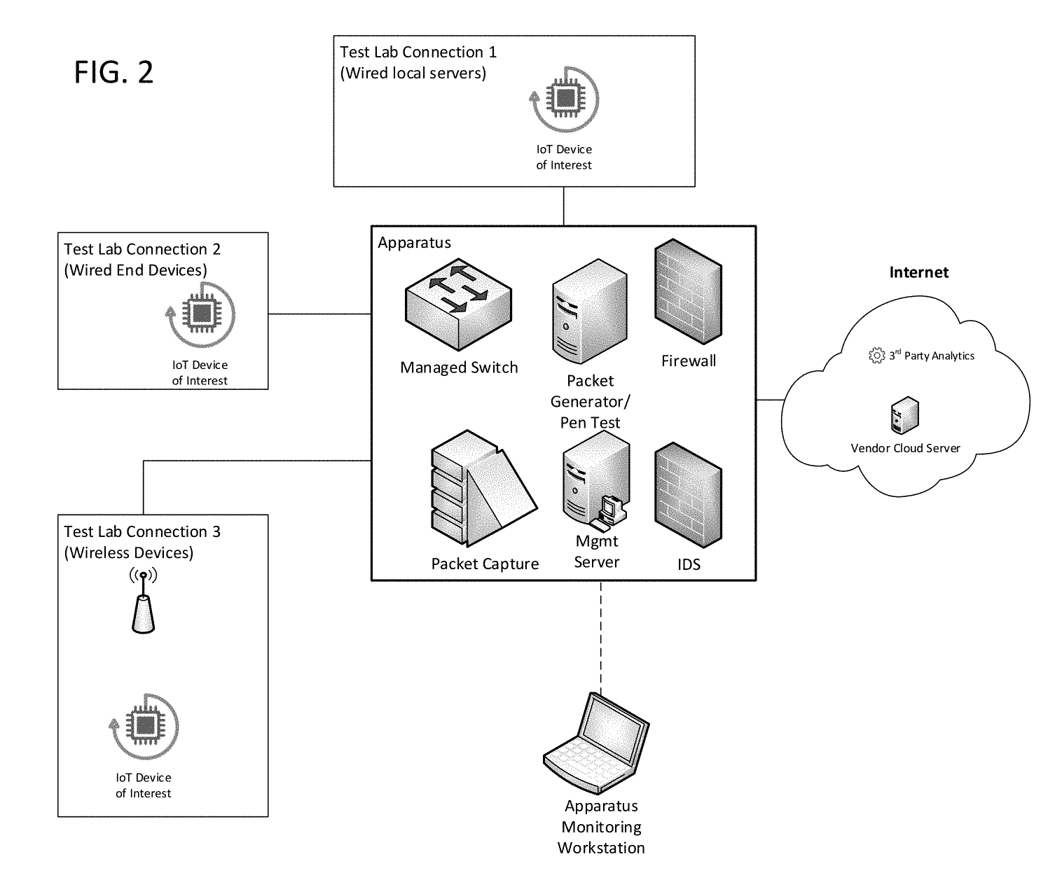

FIG. 2 shows the Apparatus as a combined layer 3 device incorporating firewall, router, switch (with interface mirroring to packet capture device), packet generation, and penetration testing on all lab and Internet facing interfaces to exhaustively simulate and capture any test deployment scenario.

Under FIG. 2, each lab interface under test, all interfaces are capable of packet generation/packet capture, IDS/IPS, firewall, and layer 2-7 inspection where applicable. This lab setup is designed to capture and monitor all traffic from each IoT device, including all primitives from edge sensors, IP based communications channels, all the way to eUtilities and other aggregating devices both on customer premises and any cloud based communications as declared by the vendor, and otherwise observe and document exceptions to declared data flows.

What is claimed:

1. An apparatus that will provide a comprehensive view of all aspects of security for IoT devices.
a. The apparatus with evaluate hardware, software and ancillary services and transport it into one functional view.
b. “Fingerprinting” and verification of vendor declared data flows verified and monitored, with exceptions to best security practices noted.
c. Rankings on adherence to security best practices will be used to evaluate against evolving industry and commercial benchmarks.
